(19) United States
(12) Patent Application Publication
(10) Pub. No.: US 2016/0062115 A1
(43) Pub. Date: Mar. 3, 2016

(54) DISPLAY SYSTEM

(71) Applicant: GM GLOBAL TECHNOLOGY OPERATIONS LLC, Detroit, MI (US)

(72) Inventor: Robert GIRSCHICK, Darmstadt (DE)

(73) Assignee: GM GLOBAL TECHNOLOGY OPERATIONS LLC, Detroit, MI (US)

(21) Appl. No.: 14/837,701

(22) Filed: Aug. 27, 2015

(30) Foreign Application Priority Data
Aug. 27, 2014 (DE) 10 2014 012 723.0

(51) Int. Cl. G02B 27/01

(52) U.S. Cl. CPC G02B 27/0101; G02B 27/0149; G02B 2027/014; G02B 2027/0159

(57) ABSTRACT

A heads-up display system is disclosed which features an imaging system for displaying an image on the windshield of a vehicle. An information source delivers information on occurring or anticipated cornering in a horizontally varying manner such that the projected image is displayed on the windshield as a function of the information of the information source.

### CROSS REFERENCE TO RELATED APPLICATION

This application claims priority to German Patent Application No. 10 2014 012 723.0, filed Aug. 27, 2014, which is incorporated herein by reference in its entirety.

### TECHNICAL FIELD

The present disclosure pertains to a display system tor displaying an image on a windshield of a vehicle.

### BACKGROUND

In modern motor vehicles, display systems such as head-up displays (HUD), which display an image on the windshield, may be used for displaying vehicle information such as vehicle speed or driving information of a navigation system. In conventional head-up displays, the image is projected on the windshield by means of mirrors or mirror systems in such a way that the image is visible to the operator above the steering wheel.

DE 11 2009 003 557 T5 describes a display system that detects the eyeball position of the operator relative to the vehicle and vertically adapts the position of the displayed image relative to the vehicle based on the detected eyeball position. In this way, it can be ensured that any operator who looks forward can see the displayed image regardless of the respective body size. No image is displayed while cornering in order to prevent the operator from becoming confused due to position changes of the image, e.g., when the operator quickly changes the viewing direction while cornering, particularly while driving through an intersection.

### SUMMARY

In accordance with the present disclosure, a display system for displaying an image on the windshield of a vehicle is provided, as well as a method fur operating such a display system, which also enables the operator to perceive the displayed image while cornering. According to an embodiment of the present disclosure, a display system includes an imaging system for displaying an image on the windshield of a vehicle and an information source that delivers information on occurring or anticipated cornering. The display system is designed for horizontally varying the position of the displayed image on the windshield as a function of the information source. When the vehicle drives through a turn or the operator of the vehicle has planned a turning maneuver, it can be assumed that the operator predominantly looks in the intended new driving direction. The displayed image can be positioned such that it is located in this viewing direction of the operator. However, it is simultaneously prevented that the displayed image follows any change of the operator's viewing direction and thereby confuses the operator because it continuously hovers in front of the operator's eyes. The displayed image particularly does not impair an assuring view in the lateral direction while turning.

The imaging system may feature a controller that is connected to the information source and a mirror, which is designed for varying the position of the mirror based on the information of the information source. An image source of the imaging system emits light that is reflected on the mirror and produces an image on the windshield. The position of the displayed image on the windshield is dependent on the position of the mirror in this case.

It would also be possible that the imaging system features a controller that has an input for an image signal and an internal screen for displaying a source image derived from the image signal. The controller is connected to the information source and designed for varying the position of the source image on the screen based on the information of the information source. A lens may be provided in order to project the source image on the windshield and thusly produce the displayed image thereon.

The information source may indicate a selected position of a turn signal lever and thereby deliver information on expected cornering to the controller.

The information source may indicate a steering angle and/or a steering direction and thereby deliver information on occurring cornering to the controller.

The imaging system may feature an input for a control signal and be designed for vertically varying the position of the displayed image as a function of the control signal. This is advantageous for also vertically shifting the displayed image into a suitable position for the operator.

The control signal may indicate the selected position of a high beam switch. When the high beam is activated, it can be assumed that the operator looks farther than when the low beam is activated and that the operator's viewing direction therefore intersects the windshield in a higher position. When the high beam is activated, it is therefore sensible to position the displayed image higher on the windshield than when the low beam is activated.

The vertical position of a point, at which the operator looks through the windshield, may depend on the vehicle speed. At higher speeds, the operator looks at or through the windshield in a higher position than at lower speeds or when the vehicle is at a standstill. The control signal may contain information on the vehicle speed. At a higher speed, it is therefore sensible to position the displayed image higher than at a lower speed in order to move the image into the respective viewing direction of the operator.

The present disclosure also pertains to a method for controlling a display system for a vehicle is provided. Information on occurring or anticipated cornering is determined, and the position of an image displayed on the windshield of a vehicle is varied as a function of the determined information

The present disclosure furthermore pertains to a computer program product having instructions that, when executed on a computer, enable the computer to operate a controller of a heads-up display in order to carry out the above-described method. A non-transitory computer readable medium includes a set of program instructions that enable a computer to control a controller for a heads-up,

The present disclosure furthermore pertained to a device for controlling a display system for a vehicle including means for determining information on occurring or anticipated cornering, and means for horizontally varying the position of an image displayed on the windshield of a vehicle as a function of the determined information.

### BRIEF DESCRIPTION OF THE DRAWINGS

The present disclosure will hereinafter be described in conjunction with the following drawing figures, wherein like numerals denote like elements.

FIG. 1 shows a schematic side view of a vehicle with a display device according to the present disclosure;

FIG. 2 shows a schematic top view of the vehicle;

FIG. 3 shows a cross section through the vehicle along the longitudinal direction thereof;

FIG. 4 shows a flowchart of the control of the display device, and

FIG. 5 shows examples of the position of the source image on a screen according to a second embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description,

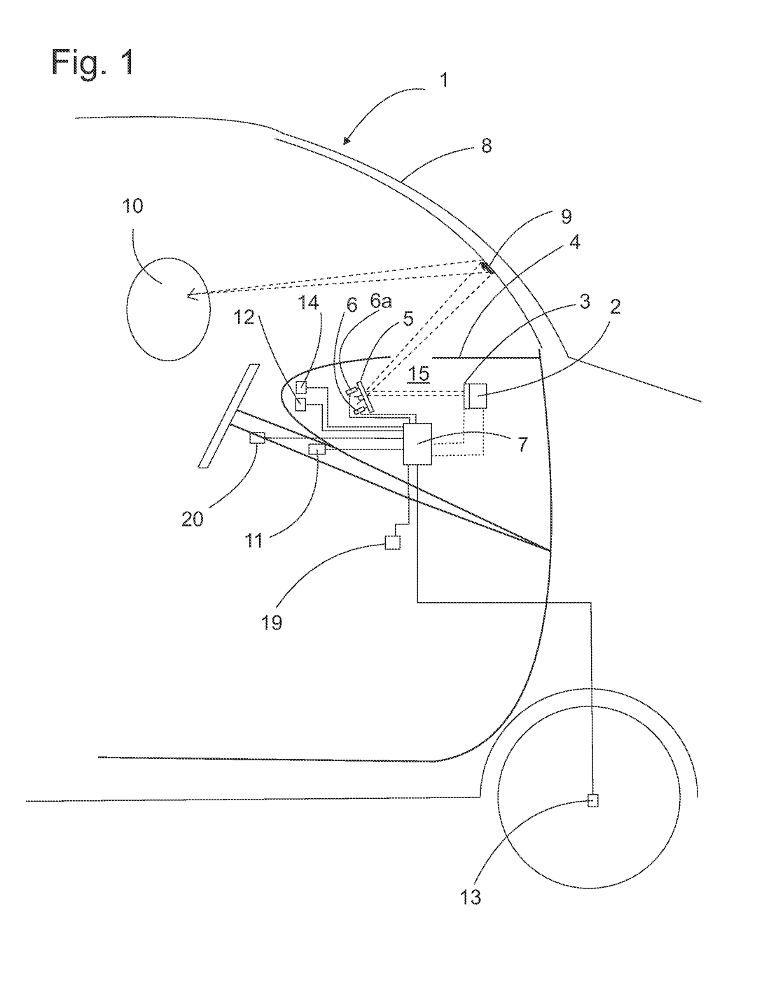

FIG. 1 shows a schematic side view of a vehicle 1 with an imaging system 15 that includes an image source 2, a screen 3, a mirror 5 that is integrated into a dashboard 4, as well as a controller 7. The image source 2 delivers an image signal to the screen 3 in order to output data of vehicle instruments in the form. of a source image. The source image may contain data of multimedia devices, control devices or display devices such as the vehicle speed and the revolutions per minute, information of a navigation system or other data such as media data. The mirror 5 reflects the source image on the windshield 8 of the vehicle 1 and thusly displays a projected image 9 thereon.

The mirror 5 is mounted on gimbals and can be adjusted by means of two actuators 6, 6a in order to horizontally and vertically shift the projected image 9 displayed on the windshield 8. The actuators 6, 6a are connected to the controller 7.

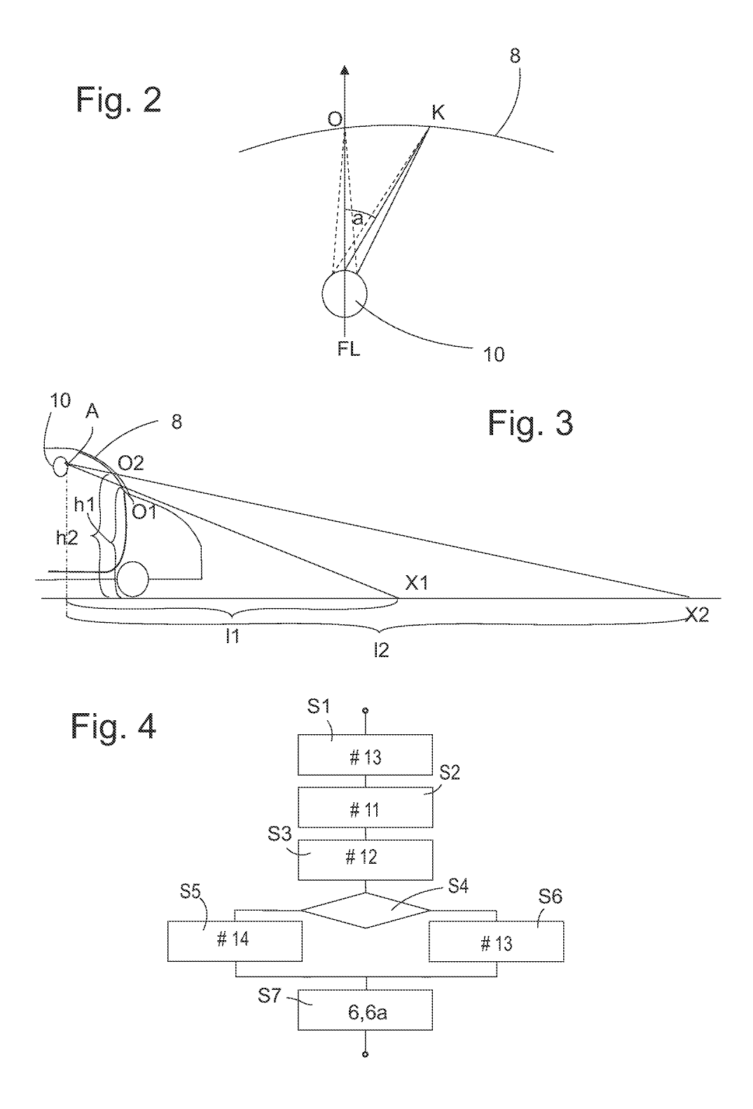

When the vehicle 1 drives straight forward, it can be assumed that the viewing direction of the operator 10 extends along the longitudinal vehicle direction FL as illustrated in the top view of the vehicle I in FIG. 2. The point, at which the view of the operator 10 intersects the windshield 8, is defined as the neutral position O. When the vehicle drives straight forward, the projected image 9 is positioned at this point O by the imaging system 115. The projected image 9 is therefore visible directly in front of the operator 10.

When the vehicle 1 drives through a turn or the operator 10 of the vehicle 1 has planned a turning maneuver, it can be assumed that the view of the operator 10 turns sideward in the direction of the turn. The operator's view then intersects the windshield 8 at the point K.

A sensor 11 connected to the controller 7 detects the steering angle. The controller 7 extrapolates the further course of the road traveled by the vehicle 1 from the steering angle and estimates the horizontal position of the point K on the windshield 8, at which the viewing direction of the operator 10 presumably intersects the windshield 8, under the assumption that the operator looks in the direction of this road. Based on this positional data, the controller 7 determines adjustment data for the position of the mirror 5 and delivers this adjustment data to the actuator is 6, 6a of the mirror 5. The actuators 6, 6a adjust the mirror 5 in such a way that the projected image 9 is positioned at the point K on the windshield 8. The operator 10 therefore always has the projected image 9 in sight, namely even if the operator's viewing direction changes horizontally due to cornering.

The controller 7 is connected to a tachometer 13 and receives a control signal that describes the vehicle speed. If the controller 7 detects that the vehicle is at a standstill, it requests the position of a turn signal lever 12 that is connected to the controller 7. If the turn signal lever 12 is in a “right” or “left” position, it can be assumed that the vehicle is stopped at an intersection and will shortly turn in the indicated direction and that the operator therefore looks or will shortly look in this direction. Consequently, a horizontal position of the point K on the windshield 8, at which the view of the operator 10 presumably intersects the windshield 8, is respectively assigned to the “right” and “left” positions of the turn signal lever 12. The controller 7 controls the position of the mirror 5 accordingly in order to position the projected image 9 at the point K on the windshield 8.

The position of the turn signal lever 12 naturally can also be evaluated while the vehicle is in motion in order to predict an impending turning maneuver. The extent, to which the controller 7 laterally shifts the projected image 9 from its neutral position O, may be dependent on the speed in this case in order to take into account the fact that the operator will adapt the speed to the radius of the upcoming turn, i.e. the higher the speed, the smaller the shift of the projected image 9.

FIG. 3 shows the vertical position of the point, at which the view of the operator 10 intersects the windshield 8, in the form of a cross section through the vehicle 1 along the longitudinal direction thereof. This vertical position is defined by the height h and also correlated with the vehicle speed. At high speeds, the operator has to take into account objects located a greater distance in front of the vehicle 1 than at low speeds. At a low speed, it can therefore be assumed that the operator 10 on average looks at a point X1 on the roadway that is located closer to the vehicle than a point X2, at which the operator looks at a high speed. The view of the operator 10 therefore intersects the windshield in a position O1 at the height h1 when the vehicle travels at a low speed. When the vehicle travels at a high speed, the view of the operator 10 intersects the windshield 8 in the position O2 at the height h2. The controller 7 receives a control signal describing the vehicle speed from the connected tachometer 13. The correlation between the speed and the position of the intersecting point between the viewing direction of the operator 10 and the windshield 8 can be determined in driving experiments and then permanently specified for the controller 7.

The controller 7 determines adjustment data for the position of the mirror 5 based on the height h of the intersecting point and delivers this adjustment data to the actuators 6, 6a of the mirror 5. The actuators 6, 6a adjust the mirror 5 in such a way that the projected image 9 is displayed in the vertical position on the windshield 8 defined by the height h.

The controller 7 may receive an additional control signal from a connected high beam switch 14. When the high beam is activated, it can be assumed that the view of the operator 10 adjusts to a distant point X, at which the roadway is illuminated particularly well. The height h is specified in the controller 7 for such instances and used for determining the adjustment data for the position of the mirror 5.

An example of such an operating sequence carried out by the controller 7 is illustrated in the form of a flowchart in FIG. 4. In step S1, the controller 7 requests the control signal describing the vehicle speed from the tachometer 13. The controller 7 also requests the information on the. steering angle from the sensor 11 in step S2 and information on the position of the turn signal lever 12 in step S3. The controller 7 then assigns an angle (a) according to FIG. 2 between the assumed viewing direction of the operator 10 and the longitudinal vehicle direction to this data. For this purpose, the controller 7 may be equipped with a look-up table that specifies the angle (a) as a function of the steering angle, the turn signal lever position and the vehicle speed. The data for adjusting the first actuator 6a of the mirror 5 is determined by the controller 7 based on the angle (a).

The position of the turn signal lever 12. is particularly important when the vehicle is at a standstill because the adjusted steering angle does not make it possible to reliably infer the future driving direction in this case.

In step S4, the controller 7 checks if the exterior lights of the vehicle are activated. If this is the case, the position of the high beam switch 14 is detected in step S5 in order to determine whether the high beam or the low beam is activated. A height of the projected image 9 displayed on the windshield, which is assigned to the respectively activated illumination type, is then selected and an adjustment of the second actuator 6 corresponding to this height is determined. If the exterior lights are not activated, only the vehicle speed signal of the tachometer 13 is available for specifying the height of the projected image 9 in step S6.

The specified adjustment data for the actuators 6, 6a is delivered to these actuators in step 7 in order to position the projected image 9 at the corresponding location of the windshield. In order to estimate the intersecting point between the viewing direction of the operator 10 and the windshield 8, it would simply be possible to assume a fixed eye position A of the operator 10 regardless of the body size and the body posture of the operator 10. However, the position of the projected image 9 can be adapted more accurately if the eye position A is also realistically estimated on an individual basis. The sensors 19 and 20 in FIG. 1 are provided for this purpose. The sensor 19 is a first position sensor that delivers adjustment parameters of the operator's seat such as the position of the seating surface, the adjustment of the backrest and the adjustment of the headrest. The sensor 20 is a second position sensor that delivers adjustment parameters of the steering wheel. The controller 7 estimates the position A of the operator's eyes in the vehicle coordinate system based on the data delivered by the sensors 19 and 20. For this purpose, the controller 7 may be equipped with a look-up table that links the adjustment parameters of the operator's seat and the steering wheel with body size data of persons that was experimentally determined beforehand. Instead of using the sensors 19 and 20, it would also be possible to provide a camera that delivers image data of the operator's face to the controller 7. The controller 7 is able to detect the eyes of the operator 10 based on this image data and estimates their position in the vehicle coordinate system.

In a second embodiment, it is assumed that the image source 2 delivers an image signal, which codes the source image, to the controller 7 of the imaging system 15. The broken lines of the connections in FIG. 1 apply to the second embodiment. The controller 7 is connected to the internal screen 3 for displaying the source image derived from the image signal. The internal screen 3 is dimensioned in such a way that the source image only covers part of the screen. The controller 7 positions the source image on the screen 3 in such a way that the image is displayed on the windshield 8 in the vertical and horizontal position determined by the controller 7. The actuators 6, 6a of the mirror 5 can be eliminated.

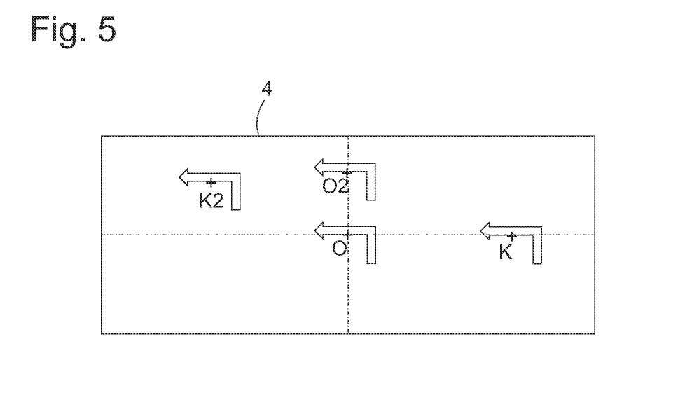

FIG. 5 shows examples of different positions of the source image in the form of an arrow on the screen 3. if the source image is displayed in the screen center 0, the projected image 9 is displayed on the windshield 8 in the neutral position O. If intended cornering is detected, the controller 7 shifts the source image into a position K, which horizontally differs from the position O, such that the projected image 9 is displayed on the windshield 8 at the point K determined by the controller 7. When the vehicle drives straightforward, the source image is shifted to a vertically different position O2 such that the projected image 9 is displayed on the windshield 8 at the point O2 determined by the controller 7. During cornering, the source image 2 is shifted to a position K2 such that the projected image 9 is displayed on the windshield 8 at the point K2 determined by the controller 7 as a function of the speed and the steering angle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-11. (canceled)

12. A display system comprising:
an imaging system for displaying an image at a projected position on the windshield of a vehicle;
an information source delivering cornering information indicative of a vehicle cornering event; and
a controller operably coupled to the imaging system and to the information source, wherein the controller is configured to horizontally vary the projected position of the image displayed on the windshield as a function of the cornering information from the information source.

13. The display system according to claim 12, wherein the imaging system further comprises an input for an image signal and a mirror for reflecting a source image derived from the image signal onto the windshield, wherein the controller is configured to vary a position of the mirror based on the cornering information.

14. The display system according to claim 12, wherein the imaging system further comprises an input for an image signal and an internal screen for displaying a source image derived from the image signal, wherein the controller is connected to the information source and configured to vary the position of the source image on the screen based on the cornering information.

15. The display system according to claim 12, wherein the information source indicates a selected position of the turn signal lever.

16. The display system according to claim 12, wherein the information source indicates at least one of a steering angle and a steering direction.

17. The display system according to claim 12, wherein the controller further comprises an input for a control signal configured to vertically vary the position of the displayed image as a function of the control signal.

18. The display system according to claim 17, wherein the control signal indicates a selected position of a high beam switch for a headlamp on the vehicle.

19. The display system according to claim 17, wherein the control signal indicates a speed of the vehicle.

20. A computer program product comprising a computer in combination with a non-transitory computer readable medium enabling the computer to operate as controller in a display system according to claim 12.

21. A non-transitory computer readable medium, on which program instructions are recorded that enable a computer to operate as a controller in a display system according to claim 12.

22. A method for controlling a display system for a vehicle comprising:
determining cornering information indicative of a vehicle cornering event; and
horizontally varying the position of an image displayed on the windshield of a. vehicle as a function of the cornering information.
